(19) United States
(12) Patent Application Publication
(10) Pub. No.: US 2007/0184709 A1
(43) Pub. Date: Aug. 9, 2007

(54) METHOD AND APPARATUS FOR A FLEXIBLE CIRCUIT AND HINGE

(75) Inventors: RICHARD J. DOMBROWSKI, LIBERTYVILLE, IL (US); JOSPEH L. ALLORE, MUNDELEIN, IL (US); JOHN H. DABBEEKEH, ZION, IL (US); OLEG V. LOS, BUFFALO GROVE, IL (US); FRANK H. STONE, WAUKEGAN, IL (US)

Correspondence Address: MOTOROLA INC, 600 NORTH US HIGHWAY 45, ROOM AS437, LIBERTYVILLE, IL, 60048-5343, US

(73) Assignee: MOTOROLA, INC., LIBERTYVILLE, IL (US)

(21) Appl. No.: 11/670,020

(22) Filed: Feb. 1, 2007

Related U.S. Application Data
(60) Provisional application No. 60/765,706, filed on Feb. 6, 2006.

(51) Int. Cl. H01R 12/24

(52) U.S. Cl. 439/495

(57) ABSTRACT

Disclosed is a method and apparatus for routing a flex circuit (102) through a hinge (112). The device includes a first housing (108) having electronic circuitry (104) and a second housing (110) having electronic circuitry (106). A hinge coupling the first housing to the second housing wherein the hinge has a barrel wherein the barrel includes a chamber (114). A flex guide (116) is positioned in the chamber of the hinge barrel and a flexible circuit routed from the first housing into the hinge barrel and the hinge chamber, into the flex guide such that the flexible circuit engages the flex guide creating a dynamic folding region in the first housing that folds upon itself as a result of rotation of the first housing and the second housing.

### FIELD OF THE INVENTION

The present invention relates generally to interconnect routing and, more particularly to interconnect routing through a hinge.

### BACKGROUND OF THE INVENTION

Portable electronic devices generally have a small size and weight in order to accommodate portability. Some devices are coupled by a hinge and fold between an open position and a closed position to accommodate functionality. In order to fold some of the device circuitry is housing in one housing and some of the circuitry is in another housing. The two circuits are electrically coupled together by a flexible circuit that is routed through the hinge that mechanically couples the two housings. Although flexible, these circuits endure highly repetitive cycling due to the opening and closing of the housing such that the mechanical wear degrades the flexible circuit. This mechanical wear ultimately leads to the failure of the device as the fatigue causes the interconnects of the circuit to fail.

The various aspects, features and advantages of the present invention will become more fully apparent to those having ordinary skill in the art upon careful consideration of the following Detailed Description with the accompanying drawings described below.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a first exemplary flex circuit hinge routing apparatus.

FIG. 2 is second exemplary flex circuit hinge routing apparatus.

FIG. 3 is a third exemplary flex circuit hinge routing apparatus.

FIG. 4 is a alternative exemplary flex circuit hinge routing apparatus.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

While the present invention is achievable by various forms of embodiment, there is shown in the drawings and described hereinafter several examples of embodiments with the understanding that the present disclosure is to be considered an exemplification of the invention and is not intended to limit the invention to the specific embodiments contained herein as will become more fully apparent from the discussion below. It is further understood that the method and apparatus for flexible circuit routing though a hinge of the present invention may be used more generally in any application where it is desirable to provide signaling and current drain reduction.

It is to be understood that the device is a portable foldable device. It may also be referred to as a mobile, remote station, user equipment, user terminal or the like. In this exemplary embodiment, the device is an electronic device such as a radiotelephone. The radiotelephone described herein is a representation of the type of wireless communication device that may benefit from the present invention. However, it is to be understood that the present invention may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) that have wireless communication capability and the like. Accordingly, any reference herein to the radiotelephone 100 should also be considered to apply equally to other portable wireless electronic devices.

Before describing in detail exemplary embodiments that are in accordance with the present invention, it should be observed that the embodiments reside primarily in combinations of method steps and apparatus components related to sleep mode of an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention.

It is further understood that the use of relational terms, if any, such as first and second, such as a first timer and a second timer, and the like are used solely to distinguish one from another entity or action without necessarily requiring or implying any actual such relationship or order between such entities or actions.

Disclosed is a method and apparatus for a flexible circuit routing hinge method and apparatus. An electronic device comprises a first housing having electronic circuitry and a second housing having electronic circuitry. A hinge that couples the first housing to the second housing, wherein the hinge has a barrel and the barrel includes a chamber. Positioned in the chamber of the barrel is a flex guide. A flexible circuit is routed from the first housing into the chamber of the hinge barrel and into the flex guide such that the flexible circuit engages the flex guide creating a dynamic folding [serpentine] region between the flex guide and the circuit board. As the housings rotate about a rotation axis of the hinge, the flex circuit folds upon itself in a serpentine like or accordion like configuration. In one embodiment, three inflection point occur in the flex circuit. A portion of the flex circuit engaged in the flex guide remains substantially fixed.

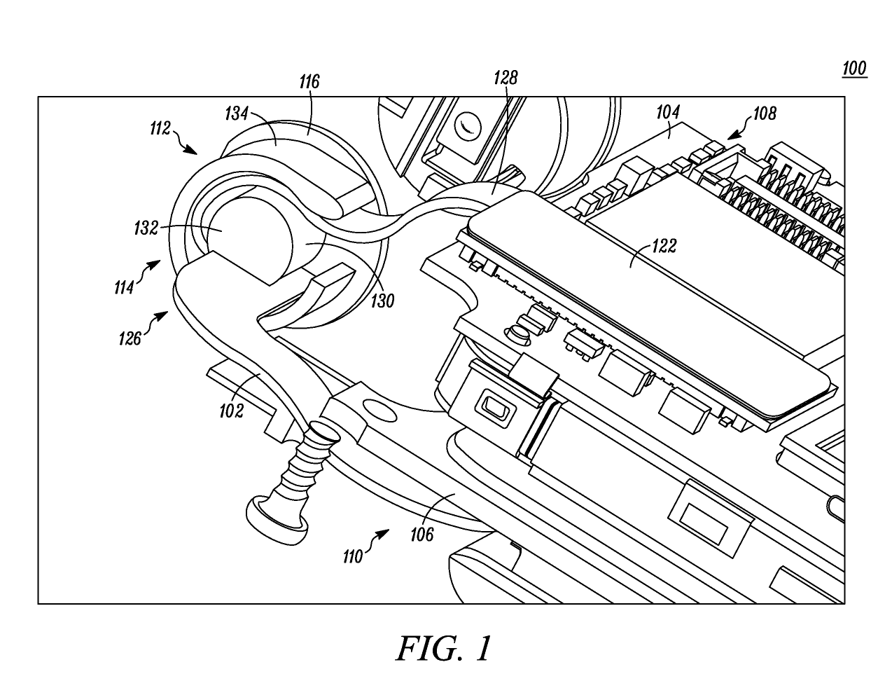

FIG. 1 illustrates one exemplary flex circuit hinge and routing apparatus. In this embodiment, a flexible (flex) circuit 102 is coupled to a first printed circuit board (PCB) 104 and a second (PCB) 106 end. The first PCB 104 is carried in a first housing portion 108, and the second PCB 106 is carried in a second housing portion 110. The flex circuit 102 is electrically attached and mechanically attached to the first PCB 104 and the second PCB 106. A first flex connector 122 connects the flex circuit to the first PCB 104. A second flex connector (not shown) connects the second PCB 106. The flex circuit may also be soldered directly to one or both of the PCBs.

The first housing portion 108 and the second housing portion 110 are rotateably coupled together by a hinge 112. The hinge provides mechanical elements that allow the first housing portion and the second housing portion to rotate relative to one another about a rotation axis 126. The hinge 112 has a chamber 114 which is a void. A flex guide 116 (also referred to as a plug) is carried in the chamber 114. The flex guide 116 has a inner guide portion 118 and an outer guide portion 120. The flex circuit 102 is configured between the inner guide portion 118 and the outer guide portion 120.

The flex guide 116, guides and fixtures the flex 102 through the hinge 112 and provides a first fixed point 128. The first flex connector 122 and the first PCB 104 provide a second fixed point 130. A dynamic portion of the flex circuit is the portion that lies between the first fixed point 128 and the second fixed point 130. This portion of the flex is dynamic as it folds and bends as the first housing 104 moves relative to the hinge and the second housing 106. The two fixed points 128, 130, in conjunction with the relative position of the flex circuit 102 from the point at which it departs from the first PCB 104, to the entry point of the flex circuit 102 into the flex guide causes the flex circuit 102 to bend in a serpentine fashion (folding upon itself). This happens as the first PCB 104 moving relative to the hinge and the second housing portion, as the device is moved to an open position for example. It is understood that the movement of the first PCB 104 results from the first housing movement relative to the second housing about the axis. It is also understood that there may be more than three inflection points.

The flex guide 116 includes an inner flex guide 132 and an outer flex guide portion 134. The inner and outer flex guides 132, 134 control the shape of the flex circuit 102 within the hinge 112 barrel or chamber 114. The inner flex guide portion 132 provides a surface for the flex circuit 102 to wrap around inside the chamber 114 and provides the first fixed point 128. The outer flex guide portion 124 guides the flex circuit out of the hinge 112 and into the first housing portion 104.

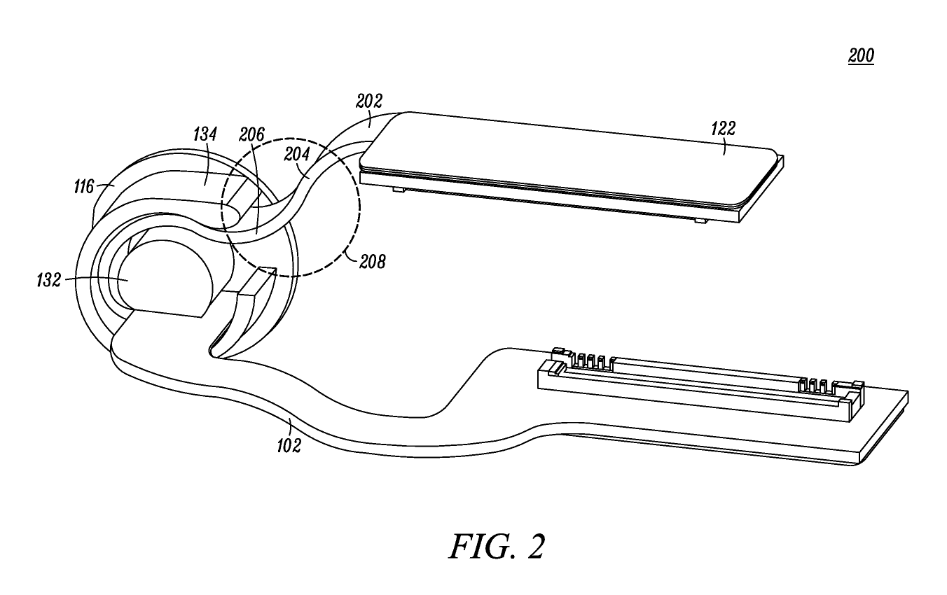

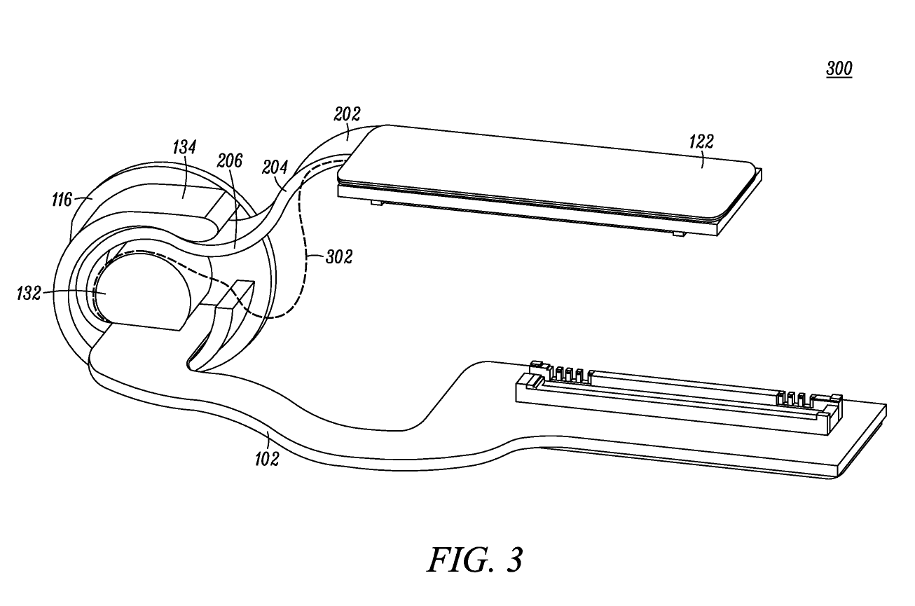

FIG. 2 and FIG. 3 illustrate the movement of the flex circuit 102 as the first PCB rotates relative to the hinge 112. FIG. 2 illustrates the flex circuit 102 in a first flex position 200 and the flex guide 116. The flex circuit 102 extends outward from the first flex connector 122, and bends downward at a first inflection point 202 in this exemplary embodiment. The first inflection point 202 is adjacent to the connection point 130 with the first PCB 104 in this exemplary embodiment. Proceeding along the length of the flex circuit 102, in-between the first PCB 104 and the flex guide 116, the flex 102 bends at a second inflection point 204 in an opposite direction from the first bend 202. This creates a sinusoidal or serpentine configuration of the flex circuit 102 which is the dynamic region 208 of the flex circuit 102. Once inside the flex guide 116, the flex circuit 102, at a third inflection point 206 bends downward and then around the flex guide 116. In this exemplary embodiment, the flex circuit wraps around the inner guide portion approximately one hundred and eighty degrees. It is understood that the flex may wrap more or less around the flex guide 116 in order to align with both PCBs.

In FIG. 3, the state or position of the flex circuit 102 is shown when the first housing is in the open position or angularly configured relative to the second housing portion 110 and the hinge 112. The bends are more exaggerated in the dynamic region 208. The dotted circle for the dynamic region, or dynamic folding region, has been removed for clarity in FIG. 3. In this exemplary embodiment, the flex guide 116 does not rotate within the hinge chamber 114 and restrains the flex circuit 102 in place as the housings rotate relative to one another.

The method comprises fixing the flex circuit 102 at the first PCB 104 and at appoint on the flex guide 116. Then rotating the first housing 104 and allowing the flex circuit 102 to bend at the three inflection points creating a greater amplitude in the serpentine configuration of the flex circuit 102.

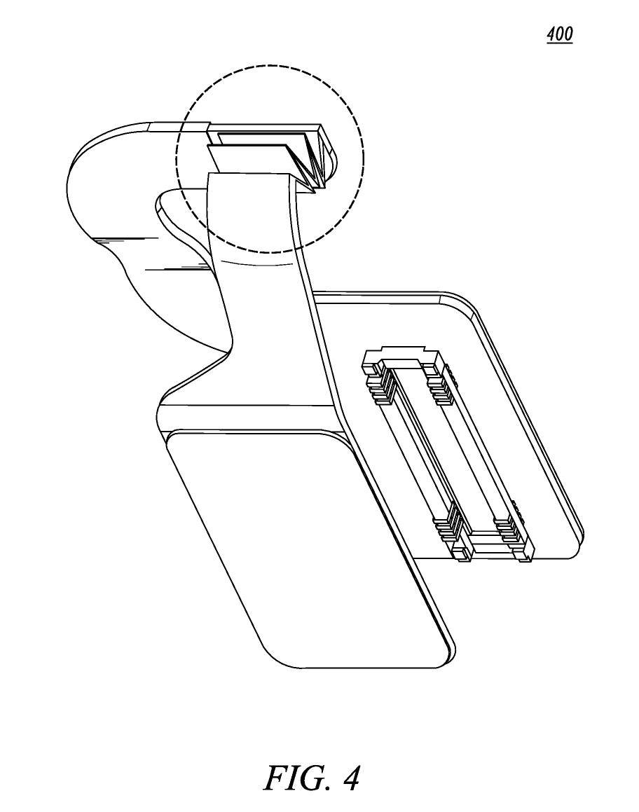

FIG. 4 illustrates an alternative embodiment, having a flex 402 that has a dynamic region 404. In this exemplary embodiment, the dynamic region 404 has bends with sharper angles that provide an accordion effect. Here as the flex circuit 402 moves as with the rotation of a PCB (not shown), the folds compress and expand.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. An electronic device comprising:
a first housing having electronic circuitry and a second housing having electronic circuitry;
a hinge coupling the first housing to the second housing, the hinge having a barrel wherein the barrel includes a chamber;
a flex guide positioned in the chamber of the hinge barrel; and
a flexible circuit routed from the first housing into the hinge barrel and the hinge chamber, into the plug such that the flexible circuit engages the plug creating a dynamic folding region in the first housing.

2. An electronic device comprising:
a first housing having a first circuit board and a second housing having a second circuit board;
a joint coupling the first housing to eth second housing, allowing the housings to rotate relative to one another about an axis;
a flexible circuit carrier positioned in the joint; and
a flexible circuit coupled to the first circuit board and the second circuit board, the flexible circuit extending away from the first circuit board into the joint and engaging the flexible circuit carrier such that the flexible circuit folds upon itself substantially inside the first housing as the first housing rotates about the axis.

3. The device of claim 2, wherein the flexi circuit maintains a constant position within the barrel.

4. The device of claim 2, wherein the flex circuit wraps substantially one half turn around the flex circuit carrier and maintain the half turn as the first housing rotates about the axis.

5. The device of claim 2, wherein the flex circuit folds upon itself in the dynamic region.

6. The device of claim 2, wherein the flex circuit folds is an accordion motion.

7. The device of claim 2, wherein the plane of flex at PCB offset from plane of axis such that the flex circuit forms an s-bend between the PCB and the flex guide.
